(19) United States
(12) Patent Application Publication
(10) Pub. No.: US 2010/0153802 A1
(43) Pub. Date: Jun. 17, 2010

(54) System and Method for Anycast Transport Optimization

(75) Inventors: Jacobus Van der Merwe, New Providence, NJ (US); Oliver Spatscheck, Randolph, NJ (US); Seungjoon Lee, Springfield, NJ (US)

Correspondence Address: AT&T Legal Department - LNA;Attn: Patent Docketing, Room 2A- 207, One AT & T Way, Bedminster, NJ, 07921, US

(73) Assignee: AT&T CORP., New York, NY (US)

(21) Appl. No.: 12/335,293

(22) Filed: Dec. 15, 2008

(51) Int. Cl. G06F 15/16; H04L 1/18; G06F 11/14

(52) U.S. Cl. 714/748; 709/203; 714/E11.113

(57) ABSTRACT

A system includes first, second, and third content servers, and an edge server. The first, second, and third content servers each are configured to cache content. The edge server is in communication with the first, second, and third content servers. The edge server is configured to receive a content request, and to request different portions of the content from each of the first, second, and third content servers based on a network cost of each of the first, second, and third content servers.

### FIELD OF THE DISCLOSURE

The present disclosure generally relates to communications networks, and more particularly relates to a system and method for anycast transport optimization.

### BACKGROUND

Packet-switched networks, such as networks based on the TCP/IP protocol suite, can distribute a rich array of digital content to a variety of client applications. One popular application is a personal computer browser for retrieving documents over the Internet written in the Hypertext Markup Language (HTML). Frequently, these documents include embedded content. Where once the digital content consisted primarily of text and static images, digital content has grown to include audio and video content as well as dynamic content customized for an individual user.

It is often advantageous when distributing digital content across a packet-switched network to divide the duty of answering content requests among a plurality of geographically dispersed servers. For example, popular Web sites on the Internet often provide links to “mirror” sites that replicate original content at a number of geographically dispersed locations. A more recent alternative to mirroring is content distribution networks (CDNs) that dynamically redirect content requests to a cache server situated closer to the client issuing the request. CDNs either co-locate cache servers within Internet Service Providers or deploy them within their own separate networks.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a diagram illustrating a communications network in accordance with one embodiment of the present disclosure;

FIG. 2 is a block diagram illustrating an anycast CDN system in accordance with one embodiment of the present disclosure;

FIG. 3 is a block diagram illustrating an alternative anycast CDN system;

FIG. 4 is a flow diagram of a method for receiving content from a plurality of content servers;

FIG. 5 is a flow diagram of an alternative method for receiving content from a plurality of content servers; and

FIG. 6 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

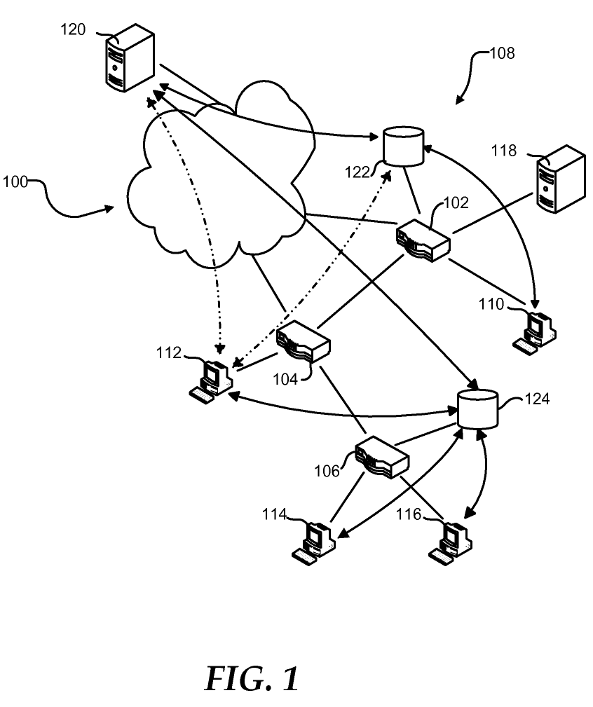

FIG. 1 shows a geographically dispersed network 100, such as the Internet. Network 100 can include routers 102, 104, and 106 that communicate with each other and form an autonomous system (AS) 108. AS 108 can connect to other ASs that form network 100 through peering points at routers 102 and 104. Additionally, AS 108 can include client systems 110, 112, 114, and 116 connected to respective routers 102, 104, and 106 to access the network 100. Router 102 can provide ingress and egress for client system 110. Similarly, router 104 can provide ingress and egress for client system 112. Router 106 can provide ingress and egress for both of client systems 114 and 116.

AS 108 can further include a Domain Name System (DNS) server 118. DNS server 118 can translate a human readable hostname, such as www.att.com, into an Internet Protocol (IP) address. For example, client system 110 can send a request to resolve a hostname to DNS server 118. DNS server 118 can provide client system 110 with an IP address corresponding to the hostname. DNS server 118 may provide the IP address from a cache of hostname-IP address pairs or may request the IP address corresponding to the hostname from an authoritative DNS server for the domain to which the hostname belongs.

Client systems 110, 112, 114, and 116 can retrieve information from a server 120. For example, client system 112 can retrieve a web page provided by server 120. Additionally, client system 112 may download content files, such as graphics, audio, and video content, and program files such as software updates, from server 120. The time required for client system 112 to retrieve the information from the server 120 normally is related to the size of the file, the distance the information travels, and congestion along the route. Additionally, the load on the server 120 is related to the number of client systems 110, 112, 114, and 116 that are actively retrieving information from the server 120. As such, the resources such as processor, memory, and bandwidth available to the server 120 limit the number of client systems 110, 112, 114, and 116 that can simultaneously retrieve information from the server 120.

Additionally, the network can include cache servers 122 and 124 that replicate content on the server 120 and that can be located more closely within the network to the client systems 110, 112, 114, and 116. Cache server 122 can link to router 102, and cache server 124 can link to router 106. Client systems 110, 112, 114, and 116 can be assigned cache server 122 or 124 to decrease the time needed to retrieve information, such as by selecting the cache server closer to the particular client system. The network distance between a cache server and client system can be determined by network cost and access time. As such, the effective network distance between the cache server and the client system may be different from the geographic distance.

When assigning cache servers 122 and 124 to client systems 110 through 116, the cache server closest to the client can be selected. The closest cache server may be the cache server having a shortest network distance, a lowest network cost, a lowest network latency, a highest link capacity, or any combination thereof. Client system 110 can be assigned cache server 122, and client systems 114 and 116 can be assigned to cache server 124. The network costs of assigning client system 112 to either of cache server 122 or 124 may be substantially identical. When the network costs associated with the link between router 102 and router 104 are marginally lower than the network costs associated with the link between router 104 and router 106, client 112 may be assigned to cache server 124.

Client system 112 may send a request for information to cache server 124. If cache server 124 has the information stored in a cache, it can provide the information to client system 112. This can decrease the distance the information travels and reduce the time to retrieve the information. Alternatively, when cache server 124 does not have the information, it can retrieve the information from server 120 prior to providing the information to the client system 112. In an embodiment, cache server 124 may attempt to retrieve the information from cache server 122 prior to retrieving the information from server 120. The cache server 124 may retrieve the information from the server 120 only once, reducing the load on server 120 and network 100 such as, for example, when client system 114 requests the same information.

Cache server 124 can have a cache of a limited size. The addition of new content to the cache may require old content to be removed from the cache. The cache may utilize a least recently used (LRU) policy, a least frequently used (LFU) policy, or another cache policy known in the art. When the addition of relatively cold or less popular content to the cache causes relatively hot or more popular content to be removed from the cache, an additional request for the relatively hot content can increase the time required to provide the relatively hot content to the client system, such as client system 114. To maximize the cost savings and time savings of providing content from the cache, the most popular content may be stored in the cache, while less popular content is retrieved from server 120.

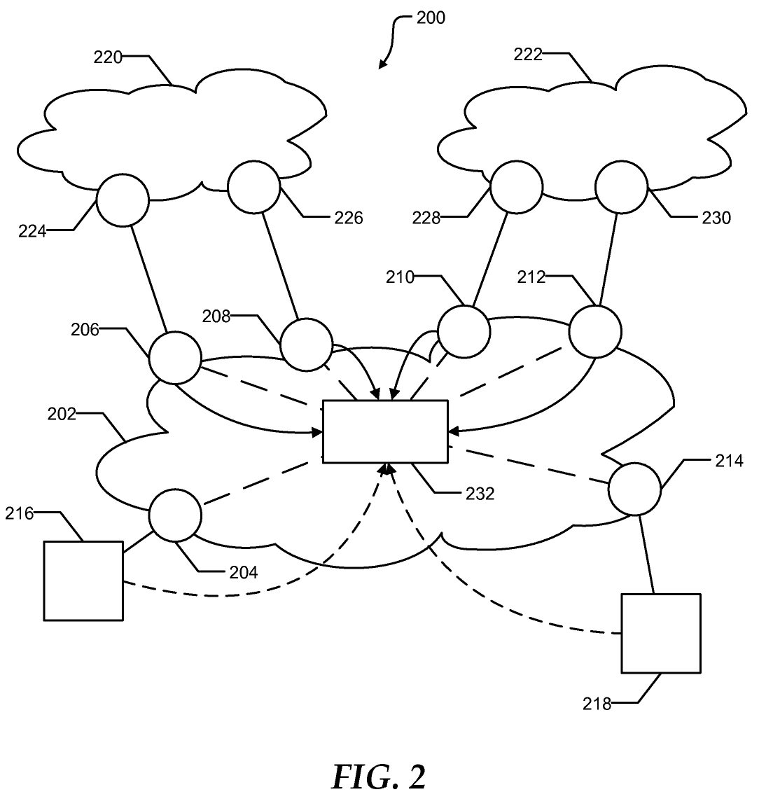

FIG. 2 illustrates an anycast CDN system 200 that can be used in conjunction with communications network 100. The anycast CDN system 200 can include a CDN provider network 202. The CDN provider network 202 can include a plurality of provider edge routers 204 through 214. The provider edge routers 204 through 214 can serve as ingress points for traffic destined for the CDN provider network 202, and egress points for traffic from the CDN provider network 202 destined for the rest of the Internet. The anycast CDN system 200 can further include cache servers 216 and 218. Cache server 216 can receive traffic from the CDN provider network 202 through provider edge router 204, and cache server 218 can receive traffic from the CDN provider network 202 through edge cache router 214. In addition to providing CDN service to clients within the CDN provider network, the anycast CDN system 200 can provide CDN service to clients within AS 220 and AS 222. AS 220 can include provider edge routers 224 and 226 with peering connections to provider edge routers 206 and 208, respectively. Similarly, AS 222 can include provider edge routers 228 and 230 with peering connections to provider edge routers 210 and 212 respectively. Requests for content from systems within either AS 220 or AS 222 may enter the CDN provider network through the appropriate peering points and be directed to either cache server 216 or 218.

Anycast CDN system 200 can also include a route controller 232. The route controller 232 can exchange routes with provider edge routers 206 through 212 within the CDN provider network 202. As such, the route controller 232 can influence the routes selected by the provider edge routers 206 through 212. Additionally, the route controller 232 can receive load information from cache servers 216 and 218.

Cache servers 216 and 218 can advertise, such as through Border Gateway Protocol (BGP), a shared anycast address to the CDN provider network 202, specifically to provider edge routers 204 and 214. Provider edge routers 204 and 214 can advertise the anycast address to the route controller 232. The route controller 232 can provide a route to the anycast address to each of the provider edge routers 206 though 212. Provider edge routers 206 through 212 can direct traffic addressed to the anycast address to either of the cache servers 216 and 218 based on the routes provided by the route controller 232. Additionally, the provider edge routers 206 through 212 can advertise the anycast address to AS 220 and AS 222. The route controller 232 can manipulate the route provided to provider edge routers 206 through 212 based on the load on the cache servers 216 and 218, network bandwidth, network cost, network distance, or any combination thereof. Altering the route to the anycast address can change which of cache servers 216 and 218 serve content to client systems within the CDN provider network 202, AS 220, and AS 222.

In an embodiment, AS 220 may be an unstable network. Traffic from client systems within the AS 220 may enter the CDN provider network 202 at both provider edge routers 206 and 208. When anycast traffic from the same client system enters the CDN provider network 202 at both provider edge routers 206 and 208, portions of the traffic may be directed to different cache servers 216 and 218. Persistent and/or secure connections may be disrupted when portions of the traffic are sent to different cache servers 216 and 218. As such, it is undesirable to provide an anycast addresses to client systems within an unstable network.

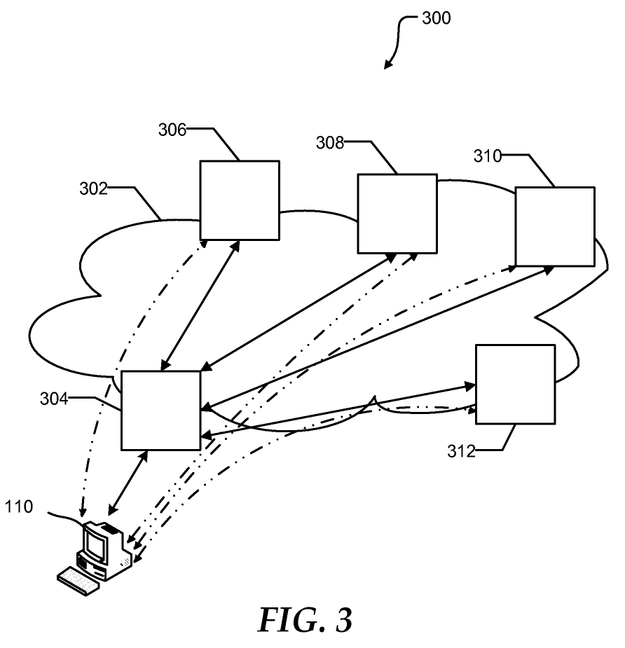

FIG. 3 illustrates a CDN system 300 including a CDN provider network 302. The CDN provider network 302 can include an edge server 304 and a plurality of content servers 306, 308, 310, and 312. The edge server 302 can serve as an ingress point for traffic destined for the CDN provider network 302, and an egress point for traffic from the CDN provider network to the client system 110. The content servers 306, 308, 310, and 312 can receive traffic from the CDN provider network 302, and can provide the content to the edge server 304 and to the client system 110.

A user can utilize the client system 110 to request specific content, such as a movie, from the CDN provider network 302. The client system 110 can send a DNS request through the CDN provider network 302 to the DNS server 118 as discussed above with reference to FIG. 1. In response to the DNS request, the client system 110 can receive an anycast address from which to obtain the content. The anycast address can direct the content request from the client system 110 to a number of servers within the CDN provider network 302, such as the content servers 306, 308, 310, and 312. After the DNS request, the client system 110 can receive metadata for the requested content, such as a content identification, the size of the content, and the like, from a metadata server (not shown) in the CDN provider network 302. The client system 110 can then use the anycast address and the metadata to request the content from the CDN provider network 302. The anycast address can route the anycast content request to the edge server 304, such that the request can be further routed to a content server containing the desired content.

Upon the edge server 304 receiving the anycast content request, the edge server can make use of tunneling technologies to distribute the anycast content request to any of the content servers 306, 308, 310, and 312. Thus the edge server 304 can determine whether to request the content from one of the content servers 306, 308, 310, and 312, or to request different portions of the content from each of the content servers. The edge server 304 can be aware of a network cost associated with each of the content servers 306, 308, 310, and 312. The network cost associated with each content server can include a server load, a network distance, a network capacity, network utilization, an available bandwidth, a server spare capacity, or any combination thereof. Based on the network cost associated with each of the content servers 306, 308, 310, and 312, the edge server 304 can request different data ranges or portions of the content from each of the content servers. Thus, the edge server 304 can break the content request up into different ranges or portions of content for each of the content servers 306, 308, 310, and 312, and the edge server 304 can then request these different content portions from the content servers 306, 308, 310, and 312.

For example, if the content server 306 has the highest load and the content server 310 has the lowest load of the content servers, the edge server 302 can request a smallest portion of the content from the content server 306 and can request a largest portion of content from the content server 310. The edge server 304 can also request different portions of the content from the content servers 308 and 312 so that all of the content is requested from the content servers. Thus, the edge server 304 can dynamically adjust the size of the different portions of content requested from each of the content servers 306, 308, 310, and 312 so that the load of the content request from client system 110 is substantially balanced on the content servers based on the network cost of each of the content servers.

Additionally, separating the content request into different sized portions based on the network cost of the content servers 306, 308, 310, and 312 can facilitate receiving the different content portions at the edge server 304 at substantially the same time. Upon receiving the different content portions from the content servers 306, 308, 310, and 312, the edge server 304 can send each of the different portions to the client system 110. Alternatively, the content servers 306, 308, 310, and 312 can send each of the different content portions directly to the client system 110 without first sending the different content portions to the edge server 304.

If upon receiving the different portions from the content servers 306, 308, 310, and 312 the edge server 304 determines that a portion of the content requested is lost, the edge server can send another content request for the missing portion to the content servers. The edge server 304 can request the entire missing portion of the content from a single content server, or can break the content request for the missing portion of the content into smaller portions based on the network cost associated with each of the content servers 306, 308, 310, and 312 as stated above. Upon the edge server 304 receiving the missing content, the edge server can send the missing content to the client system 110. Alternatively, if the client system 110 determines that one of the portions is missing the client system can request the missing portion through another anycast content request, which can be routed to the edge server 304 as stated above.

In another embodiment, the client system 110 can break the content request into different portions prior to sending the content request to the edge server 304. Upon receiving the requests for the different portions, the edge server 304 can either send each of the content requests to a different content server or further break the different portions into smaller portions based on the network cost associated with each of the content servers 306, 308, 310, and 312. In another embodiment, the edge server 304 can be a load balancing switch, a CDN router, or any similar device that can determine the network cost associated with each of the content servers 306, 308, 310, and 312.

It should be understood that the edge server 304 can be connected to multiple client systems, and that the edge server can break up the content request from each of the client systems as discussed above in relation to the content request from client system 110. It should also be understood that the CDN provider network 302 can further include multiple edge servers connected to multiple content servers in the CDN provider network, and that the other edge servers can operate similarly as discussed above for the edge server 304.

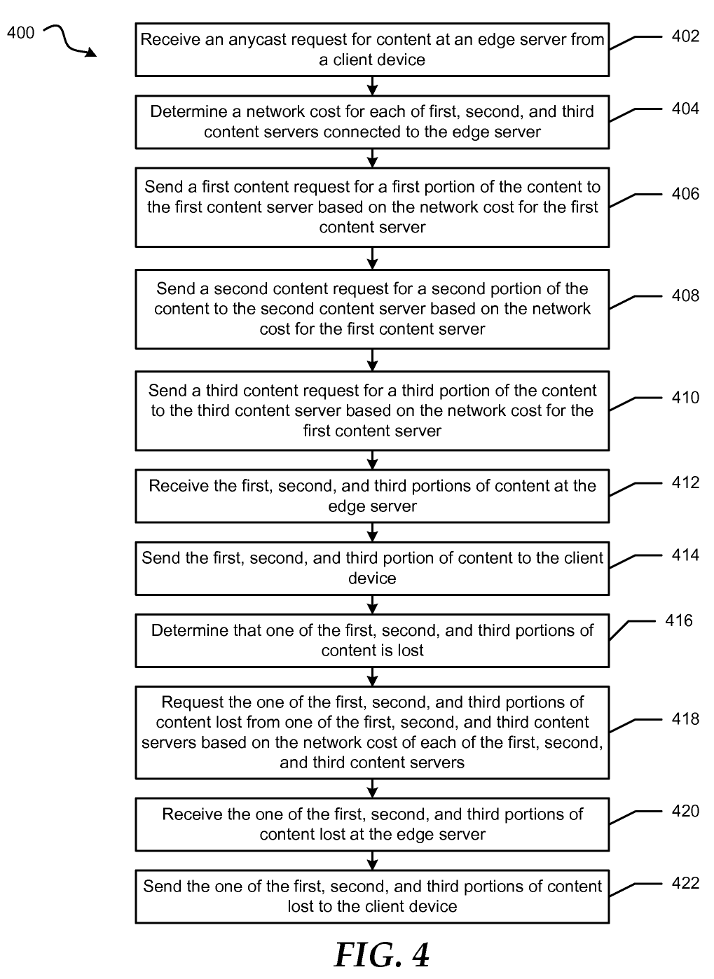

FIG. 4 shows a method 400 for receiving content from a plurality of content servers. At block 402, an anycast request for content is received at an edge server from a client device. A network cost for each of first, second, and third content servers connected to the edge server is determined at block 404. The network cost associated with each content server can include a server load, a network distance, a network capacity, network utilization, an available bandwidth, a server spare capacity, or any combination thereof. At block 406, a first content request for a first portion of the content is sent to the first content server based on the network cost for the first content server. A second content request for a second portion of the content is sent to the second content server based on the network cost for the second content server at block 408. At block 410, a third content request for a third portion of the content is sent to the third content server based on the network cost for the third content server.

At block 412, the first, second, and third portions of content are received at the edge server. The first, second, and third portions of content are sent to the client device at block 414. At block 416, it is determined that one of the first, second, and third portions of content is lost. The one of the first, second, and third portions of content lost is requested from one of the first, second, and third content servers based on the network cost of each of the first, second, and third content servers at block 418. At block 420, the one of the first, second, and third portions of content lost is received at the edge server. The one of the first, second, and third portions of content lost is sent to the client device at block 422.

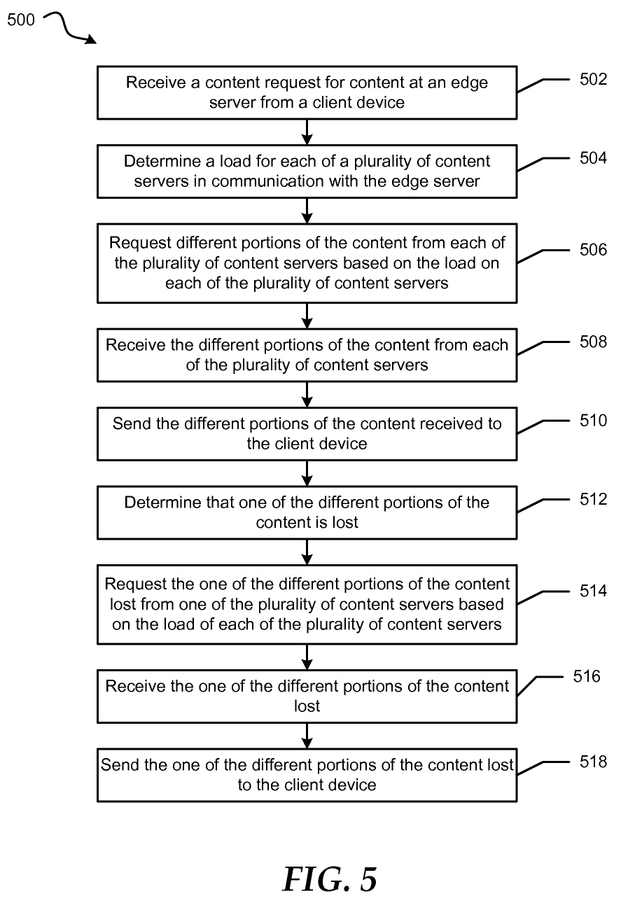

FIG. 5 shows an alternative method 500 for receiving content from a plurality of content servers. At block 502, a content request is received at an edge server from a client device. A load for each of a plurality of content servers in communication with the edge server is determined at block 504. At block 506, different portions of the content are requested from each of the content servers based on the load on each server. The different portions of the content are received from each of the plurality of content servers at block 508. At block 510, the different portions of the content are sent to the client device. It is determined that one of the different portions of the content is lost at block 512. At block 514, the one of the different portions of the content lost is requested from one of the content servers based on the load on each server. The one of the different portions of the content lost is received at block 516. At block 518, the one of the different portions of the content lost is sent to the client device.

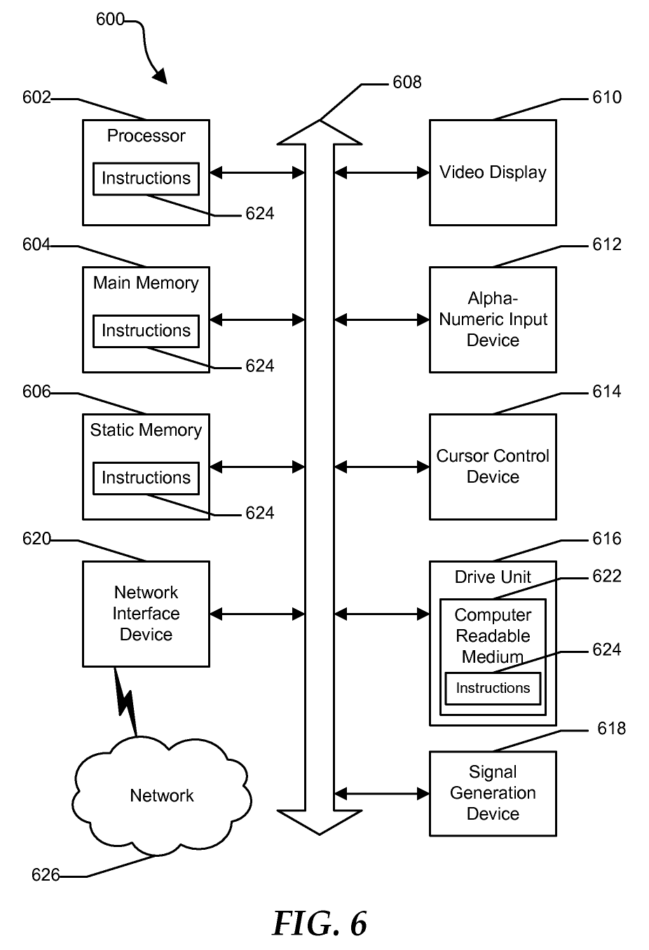

FIG. 6 shows an illustrative embodiment of a general computer system 600 in accordance with at least one embodiment of the present disclosure. The computer system 600 can include a set of instructions that can be executed to cause the computer system to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
receiving an anycast request for content at an edge server from a client device;
determining a network cost for each of first, second, and third content servers connected to the edge server;
sending a first content request for a first portion of the content to the first content server based on the network cost for the first content server;
sending a second content request for a second portion of the content to the second content server based on the network cost for the second content server;
sending a third content request for a third portion of the content to the third content server based on the network cost for the third content server;
receiving the first, second, and third portions of the content at the edge server; and
sending the first, second, and third portions of the content to the client device.

2. The method of claim 1 wherein the network costs is a server load, a network distance, a network capacity, a network utilization, an available bandwidth, a server spare capacity, or any combination thereof.

3. The method of claim 1 further comprising:
determining that one of the first, second, and third portions of content is lost;
requesting the lost portions of content from one of the first, second, and third content servers based on the network cost of each of the first, second, and third content servers;
receiving the lost portions of content; and
sending the lost portions of content to the client device.

4. The method of claim 1 wherein the first, second, and third portions are different data ranges of the content.

5. The method of claim 4 wherein the different data ranges are different sizes based on the network cost for each of the first, second, and third content servers.

6. The method of claim 1 wherein the edge server is selected from a group consisting of a load balancing switch and a content distribution network router.

7. A method comprising:
receiving a content request at an edge server from a client device;
determining a load of each of a plurality of content servers in communication with the edge server;
requesting different portions of the content request from each of the content servers based on the load on each of the content servers;
receiving the different portions of content from the content servers; and
sending the different portions of content to the client device.

8. The method of claim 7 wherein the different portions are different data ranges of the content.

9. The method of claim 8 wherein the different data ranges are different sizes based on the load of each of the plurality of content servers.

10. The method of claim 7 further comprising:
determining that one of the different portions of content is lost;
requesting the one of the different portions of content lost from one of the plurality of content servers based on the load for each of the plurality of content servers;
receiving the one of the different portions of content lost; and
sending the one of the different portions of content lost to the client device.

11. The method of claim 7 wherein the edge server is selected from a group consisting of a load balancing switch and a content distribution network router.

12. A system comprising:
first, second, and third content servers, each configured to cache content; and
an edge server in communication with the first, second, and third content servers, the edge server configured to receive a content request, to request different portions of the content from each of the first, second, and third content servers based on a network cost of each of the first, second, and third content servers.

13. The system of claim 12 wherein the network cost is a server load, a network distance, a network capacity, a network utilization, an available bandwidth, a server spare capacity, or any combination thereof.

14. The system of claim 12 wherein the first, second, and third portions are different data ranges of the content.

15. The system of claim 14 wherein the different data ranges are different sizes based on the network cost for each of the first, second, and third content servers.

16. The system of claim 12 wherein the edge server is further configured to determine that one of the different portions of the content is lost, and further configured to request the one of the different portions lost from one of the first, second, and third content servers based on the network cost of each of the first, second, and third content servers.

17. A computer readable medium comprising a plurality of instructions to manipulate a processor, the plurality of instructions comprising:
instructions to receive an anycast request for content at an edge server from a client device;
instructions to determine a network cost for each of first, second, and third content servers connected to the edge server;
instructions to send a first content request for a first portion of the content to the first content server based on the network cost for the first content server;
instructions to send a second content request for a second portion of the content to the second content server based on the network cost for the second content server;
instructions to send a third content request for a third portion of the content to the third content server based on the network cost for the third content server;
instructions to receive the first, second, and third portions of the content at the edge server; and
instructions to send the first, second, and third portions of the content to the client device.

18. The computer readable medium of claim 17 wherein the network costs is a server load, a network distance, a network capacity, a network utilization, an available bandwidth, a server spare capacity, or any combination thereof.

19. The computer readable medium of claim 17 further comprising:
instructions to determine that one of the first, second, and third portions of content is lost;
instructions to request the lost portions of content from one of the first, second, and third content servers based on the network cost of each of the first, second, and third content servers;
instructions to receive the lost portions of content; and
instructions to send the lost portions of content to the client device.

20. The computer readable medium of claim 17 wherein the first, second, and third portions are different data ranges of the content.

21. The computer readable medium of claim 20 wherein the different data ranges are different sizes based on the network cost for each of the first, second, and third content servers.

22. A computer readable medium comprising a plurality of instructions to manipulate a processor, the plurality of instructions comprising:
instructions to receive a content request at an edge server from a client device;
instructions to determine a load of each of a plurality of content servers in communication with the edge server;
instructions to request different portions of the content request from each of the content servers based on the load on each of the content servers;
instructions to receive the different portions of content from the content servers; and
instructions to send the different portions of content to a client device.

23. The computer readable medium of claim 22 wherein the different portions are different data ranges of the content.

24. The computer readable medium of claim 23 wherein the different data ranges are different sizes based on the load of each of the first, second, and third content servers.

25. The computer readable medium of claim 22 further comprising:
instructions to determine that one of the different portions of content is lost;
instructions to request the one of the different portions of content lost from one of the plurality of content servers based on the load for each of the plurality of content servers;
instructions to receive the one of the different portions of content lost; and
instructions to send the one of the different portions of content lost to the client device.
